(19) United States
(12) Patent Application Publication
(10) Pub. No.: US 2026/0106378 A1
(43) Pub. Date: Apr. 16, 2026

(54) ANTENNA

(71) Applicants: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP); Kanazawa Institute of Technology, Nonoichi-shi, Ishikawa (JP)

(72) Inventors: Yutaro MIKI, Osaka-shi, Osaka (JP); Ichiro KUWAYAMA, Osaka-shi, Osaka (JP); Suguru YAMAGISHI, Osaka-shi, Osaka (JP); Keisuke NOGUCHI, Nonoichi-shi, Ishikawa (JP)

(73) Assignees: Sumitomo Electric Industries, Ltd., Osaka-shi, Osaka (JP); Sumitomo Wiring Systems, Ltd., Yokkaichi-shi, Mie (JP); AutoNetworks Technologies, Ltd., Yokkaichi-shi, Mie (JP); Kanazawa Institute of Technology, Nonoichi-shi, Ishikawa (JP)

(21) Appl. No.: 19/114,668

(22) PCT Filed: Jul. 6, 2023
(86) PCT No.: PCT/JP2023/025153

§ 371 Date: Mar. 24, 2025

(30) Foreign Application Priority Data
Sep. 30, 2022 (JP) 2022-157687

(51) Int. Cl. H01Q 9/30; H01Q 1/48

(52) U.S. Cl. CPC H01Q 9/30; H01Q 1/48

(57) ABSTRACT

This antenna includes a first plate-shaped conductor, and a columnar conductor provided at a plate surface of the first plate-shaped conductor so as to protrude therefrom. A distal end of the columnar conductor has a feeding point, and a sectional area of a cross-section of the columnar conductor along the plate surface is larger than an area of an end surface of the distal end.

### CROSS-REFERENCE TO RELATED APPLICATIONS

This application is the U.S. national stage of PCT/JP2023/025153 filed on Jul. 6, 2023, which claims priority of Japanese Patent Application No. JP 2022-157687 filed on Sep. 30, 2022, the contents of which are incorporated herein.

### TECHNICAL FIELD

The present disclosure relates to an antenna.

### BACKGROUND

Conventional examples of an antenna for a mobile station in a mobile communication system include an antenna having a capacitance loading plate at an end of a monopole element.

The monopole antenna having the capacitance loading plate can achieve a low profile and therefore may be used as an in-vehicle antenna (see, for example, Japanese Laid-Open Patent Publication No. 2006-74206).

In recent years, mobile communication systems have increasingly had a multiband configuration and antennas for a mobile station are required to have a wide band.

However, in the monopole antenna having the capacitance loading plate, although a signal in a comparatively low frequency band of 1 GHz or lower can be transmitted and received, there is a case where a signal in a comparatively high frequency band of several GHz or higher, e.g., SUB-6 in a 5th-generation mobile communication system cannot be transmitted and received.

Thus, the monopole antenna having the capacitance loading plate has a problem that it is difficult to adapt to a wide band, while a low profile can be achieved.

Accordingly, an object of the present disclosure is to provide an antenna that is adaptable to a wide band while achieving a low profile.

### SUMMARY

An antenna according to an embodiment includes: a first plate-shaped conductor; and a columnar conductor provided at a plate surface of the first plate-shaped conductor so as to protrude therefrom. A distal end of the columnar conductor has a feeding point. A sectional area of a cross-section of the columnar conductor along the plate surface is larger than an area of an end surface of the distal end.

### Effects of the Present Disclosure

According to the present disclosure, it is possible to provide an antenna that is adaptable to a wide band while achieving a low profile.

### BRIEF DESCRIPTION OF DRAWINGS

FIG. 1 is a perspective view showing an example of an antenna according to a first embodiment.

FIG. 2A is a front view of the antenna according to the first embodiment.

FIG. 2B is a side view of the antenna according to the first embodiment.

FIG. 3 is a sectional view of the antenna according to the first embodiment along X-Z plane.

FIG. 4 is a graph showing a contour curve of a side surface in a cross-section of a columnar conductor along a plane including a revolution axis.

FIG. 5 is a perspective view showing an example of an antenna according to a second embodiment.

FIG. 6 is a side view of the antenna according to the second embodiment.

FIG. 7 is a sectional view of the antenna according to the second embodiment along X-Z plane.

FIG. 8 is a perspective view of an antenna according to a third embodiment.

FIG. 9 is a sectional view of the antenna according to the third embodiment along X-Z plane.

FIG. 10 is a sectional view as seen in A-A arrow direction in FIG. 9.

FIG. 11 is a perspective view of an antenna according to a fourth embodiment.

FIG. 12 is a perspective view of an antenna according to a fifth embodiment.

FIG. 13A is a perspective view of an antenna according to a modification.

FIG. 13B is a front view of the antenna according to the modification.

FIG. 14A is a perspective view of an antenna according to another modification.

FIG. 14B is a front view of the antenna according to the other modification.

FIG. 15 is a perspective view of an antenna according to Comparative example.

FIG. 16 is a sectional view of the antenna according to Comparative example along X-Z plane.

FIG. 17 shows a frequency characteristic of return loss in Comparative example 1.

FIG. 18 shows a frequency characteristic of return loss in Example 1.

FIG. 19 shows a frequency characteristic of return loss in Example 2.

FIG. 20 shows a frequency characteristic of return loss in Example 3.

FIG. 21 shows a frequency characteristic of return loss in Example 4.

FIG. 22 shows a frequency characteristic of return loss in Example 5.

### DETAILED DESCRIPTION OF PREFERRED EMBODIMENTS

First, contents of embodiments are listed and described.

In a first aspect, an antenna according to an embodiment includes: a first plate-shaped conductor; and a columnar conductor provided at a plate surface of the first plate-shaped conductor so as to protrude therefrom. A distal end of the columnar conductor has a feeding point. A sectional area of a cross-section of the columnar conductor along the plate surface is larger than an area of an end surface of the distal end.

With the above configuration, the first plate-shaped conductor functions as a capacitance loading plate, and thus it is possible to adapt to a signal in a comparatively low frequency band while achieving a low profile.

Further, if a side surface of the columnar conductor connecting the feeding point and the first plate-shaped conductor has an appropriate shape, change in the characteristic impedance of the first columnar conductor over a range from the feeding point to the first plate-shaped conductor can be made mild. Thus, it is possible to reduce return loss of the antenna with respect to a signal in a comparatively high frequency band.

In a second aspect, in the antenna of the first aspect, a shape of the columnar conductor may be a shape having a taper-shaped side surface tapered from the first plate-shaped conductor side toward the distal end side.

In this case, the feeding point and the first plate-shaped conductor can be smoothly connected. As a result, change in the characteristic impedance of the columnar conductor over a range from the feeding point to the first plate-shaped conductor can be made mild. Thus, it is possible to reduce return loss of the antenna with respect to a signal in a comparatively high frequency band.

Accordingly, it is possible to obtain an antenna that is adaptable to a wide frequency band while achieving a low profile.

In a third aspect, in the antenna of the first or the second aspect, the side surface may be a convex curved surface.

In this case, it is possible to appropriately adjust change in the characteristic impedance of the columnar conductor.

In a fourth aspect, in the antenna of any one of the first through the third aspects, a shape of the side surface may be a side surface shape of a solid of revolution about a revolution axis that is a line perpendicular to the plate surface, and when the revolution axis is defined as a y axis and a line perpendicular to the revolution axis at the distal end is defined as an x axis, a contour curve of the side surface in a cross-section of the columnar conductor along a plane including the revolution axis may satisfy the following formula:

$$y = a {x}^{P}$$

where x≥0, a>0, and P≥1.
In this case, it is possible to more appropriately adjust change in the characteristic impedance of the columnar conductor.

In a fifth aspect, in the antenna of the the first aspect, a shape of the columnar conductor may be a shape having a step-shaped side surface expanding stepwise from the distal end side toward the first plate-shaped conductor side.

In this case, the feeding point and the first plate-shaped conductor can be smoothly connected through the step-shaped side surface expanding stepwise, whereby change in the characteristic impedance of the columnar conductor can be made milder.

In a sixth aspect, in the antenna of any one of the first through the fifth aspects, the first plate-shaped conductor may have a band shape.

In this case, the size of the antenna as seen in a plan view can be reduced, whereby the antenna can be downsized.

In a seventh aspect, in the antenna of the sixth aspect, the columnar conductor may be provided on a first end side in a longitudinal direction of the first plate-shaped conductor.

In this case, the size can be made compact and a distance from the second end opposite to the first end to the columnar conductor can be appropriately ensured, whereby a low profile can be more easily achieved.

In an eighth aspect, in the antenna of the the sixth or the seventh aspect, a width dimension of the first plate-shaped conductor and a width dimension of the cross-section of the columnar conductor along the plate surface may be the same. In this case, the size of the antenna as seen in a plan view can be more reduced.

In a ninth aspect, in the antenna of the eighth aspect, a short side on a first end side in a longitudinal direction of the first plate-shaped conductor may have a shape along a contour shape of the cross-section of the columnar conductor along the plate surface. In this case, the size of the antenna as seen in a plan view can be even more reduced.

In a tenth aspect, in the antenna of any one of the first through the ninth aspects, the columnar conductor may be provided at a position shifted from a center of the first plate-shaped conductor, on the plate surface.

In this case, a distance on the first plate-shaped conductor from the columnar conductor to another end edge across the center of the first plate-shaped conductor can be ensured as necessary, whereby it is possible to favorably adapt to a signal in a comparatively low frequency band.

In an eleventh aspect, in the antenna of the the tenth aspect, a center of the first plate-shaped conductor may be a center of gravity of a contour shape of the first plate-shaped conductor as seen in a plan view, or a center of a circumscribed circle of the contour shape.

In this case, the center of gravity of the contour shape and the center of the circumscribed circle thereof are favorable as the center of the first plate-shaped conductor.

In a twelfth aspect, the antenna of any one of the first through the eleventh aspects may further include a short-circuit conductor provided at the plate surface so as to protrude therefrom and grounding the first plate-shaped conductor.

In this case, it is possible to appropriately adjust the input impedance of the antenna by the short-circuit conductor, whereby it is possible to adapt the antenna to a wider frequency band.

In a thirteenth aspect, in the antenna of the twelfth aspect, the short-circuit conductor may have a plate shape curved in accordance with a side surface of the columnar conductor, and may be located so as to be opposed to the side surface of the columnar conductor with a predetermined interval therebetween.

In this case, a comparatively low frequency band of adaptable frequency bands can be made wide.

In a fourteenth aspect, the antenna of any one of the first through the thirteenth aspects may further include a second plate-shaped conductor provided at a side surface of the columnar conductor so as to protrude therefrom and located on the plate surface side of the first plate-shaped conductor so as to be opposed to the first plate-shaped conductor.

In this case, the antenna can be configured with two elements and can have a wide band owing to increase in the resonance frequency.

Hereinafter, preferred embodiments will be described with reference to the drawings.

At least parts of the embodiments described below may be arbitrarily combined.

### Entire Configuration of First Embodiment

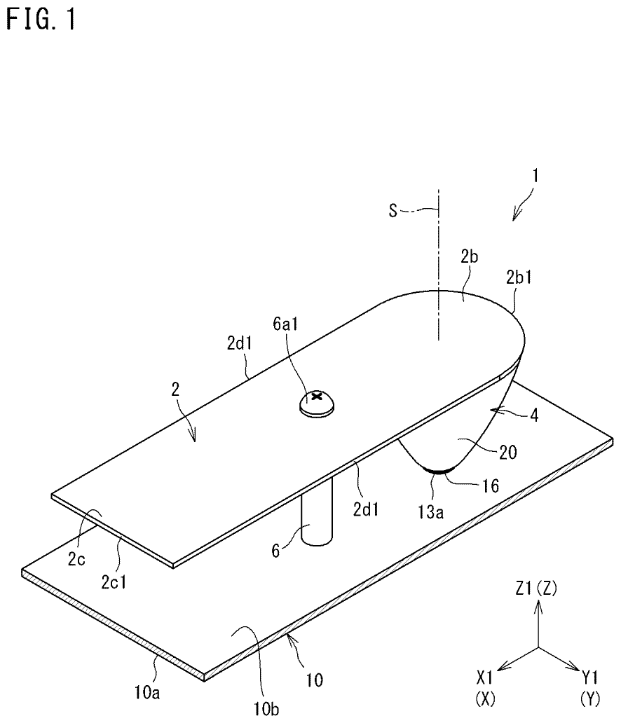

FIG. 1 is a perspective view showing an example of an antenna according to the first embodiment.

This antenna 1 is an in-vehicle antenna mounted to a roof or the like of a vehicle, for example. The antenna 1 is used for a mobile station in a mobile communication system mounted to a vehicle such as an automobile, a bus, or a railroad vehicle. The antenna 1 can be used for a 5th-generation mobile communication system.

In the following description, three directions perpendicular to each other are defined as an X direction, a Y direction, and a Z direction, as shown in the drawings. In FIG. 1, an arrow direction of the X direction is defined as an X1 direction, and a direction opposite to the arrow direction is defined as an X2 direction. In FIG. 1, an arrow direction of the Y direction is defined as a Y1 direction, and a direction opposite to the arrow direction is defined as a Y2 direction. In FIG. 1, an arrow direction of the Z direction is defined as a Z1 direction, and a direction opposite to the arrow direction is defined as a Z2 direction.

The antenna 1 is provided on aground conductor 10. The ground conductor 10 has a plate shape parallel to X-Y plane. The ground conductor 10 is a roof of a vehicle, for example. In FIG. 1, a part of the ground conductor 10 is shown.

The antenna 1 includes a first plate-shaped conductor 2, a columnar conductor 4, and a short-circuit conductor 6.

The first plate-shaped conductor 2 has a plate shape along X-Y plane. Therefore, the first plate-shaped conductor 2 and the ground conductor 10 are parallel to each other. The first plate-shaped conductor 2 extends in a band shape along the X direction.

The band shape refers to a thin and long extending shape having a constant width like a band or a belt, and here, refers to a shape including a thin and long rectangular shape like the first plate-shaped conductor 2.

The columnar conductor 4 and the short-circuit conductor 6 protrude in the Z2 direction from the first plate-shaped conductor 2. A distal end of the columnar conductor 4 and a distal end of the short-circuit conductor 6 are connected to the ground conductor 10. Thus, the first plate-shaped conductor 2 is placed in a state of being opposed to the ground conductor 10.

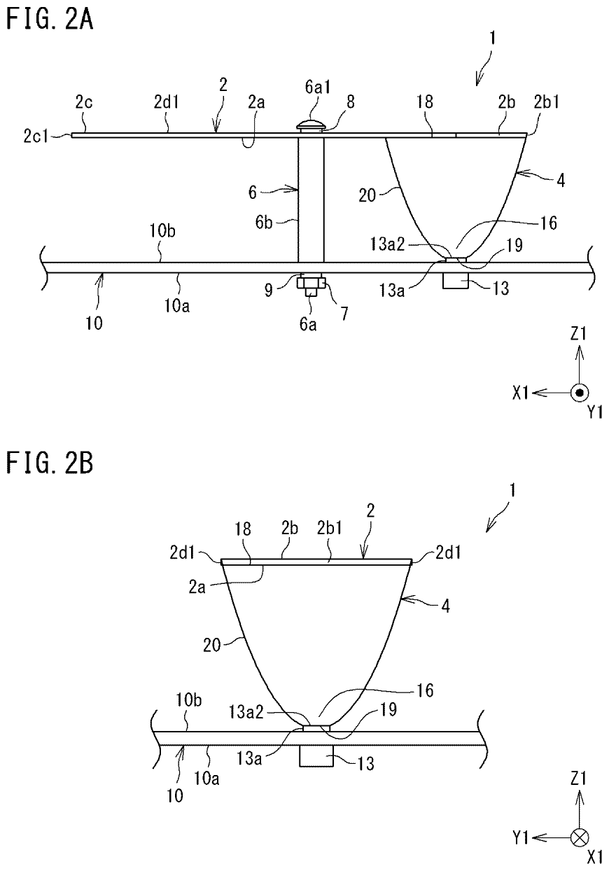

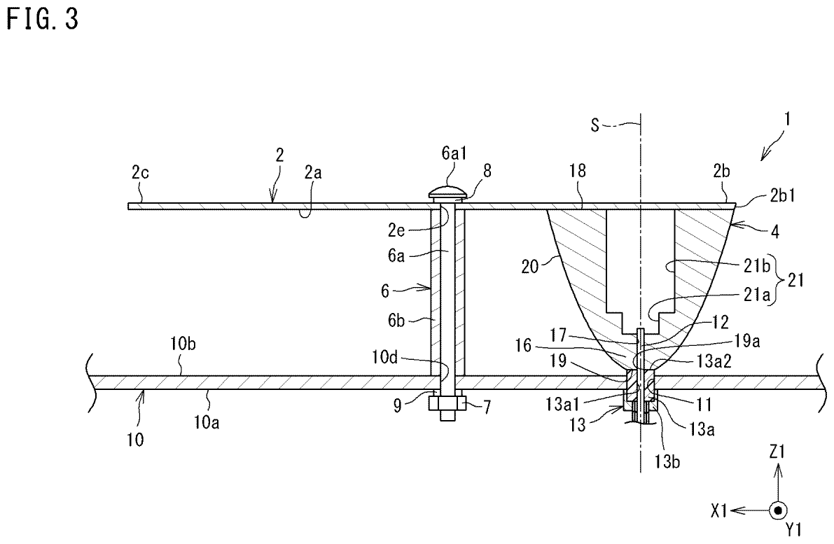

FIG. 2A is a front view of the antenna 1 according to the first embodiment, and FIG. 2B is a side view of the antenna 1 according to the first embodiment. FIG. 3 is a sectional view of the antenna 1 according to the first embodiment along X-Z plane. FIG. 3 shows across-section passing through the Y-direction center of the antenna 1.

As shown in FIG. 2A and FIG. 2B, a connector 13 to which a coaxial cable (not shown) is connected is provided at a first surface 10a of the ground conductor 10.

As shown in FIG. 3, a hole 11 is provided in the ground conductor 10. The connector 13 is inserted into the hole 11.

The connector 13 has a cylindrical insulation member 13a, a pin 12, and a body portion 13b.

The insulation member 13a is inserted into the hole 11. The insulation member 13a has a through hole 13a1 penetrating in the Z direction.

The pin 12 is inserted into the through hole 13a1. Thus, the pin 12 is insulated from the ground conductor 10 by the insulation member 13a. The pin 12 protrudes from a second surface 10b and an end surface 13a2 of the insulation member 13a. The second surface 10b is a surface of the ground conductor 10 that faces toward the Z1 direction side. The pin 12 is connected to an inner conductor (not shown) of the coaxial cable.

The body portion 13b connects an outer conductor (not shown) of the coaxial cable and the ground conductor 10.

The columnar conductor 4 is a columnar member formed by a conductor such as copper. The columnar conductor 4 is provided at a plate surface 2a of the first plate-shaped conductor 2 so as to protrude therefrom. The plate surface 2a is a plate surface of the first plate-shaped conductor 2 that faces in the Z2 direction.

The columnar conductor 4 has a distal end 16, a base end surface 18, and a side surface 20.

The distal end 16 has an end surface 19. The end surface 19 is an end surface of the columnar conductor 4 that faces in the Z2 direction. The base end surface 18 is an end surface that faces in the Z1 direction opposite to the end surface 19. The side surface 20 is a surface connecting the end surface 19 and the base end surface 18.

The side surface 20 has a shape tapered from the base end surface 18 (first plate-shaped conductor 2) side toward the distal end 16 side.

The base end surface 18 contacts with the plate surface 2a of the first plate-shaped conductor 2. Thus, the columnar conductor 4 and the first plate-shaped conductor 2 are electrically connected to each other. The first plate-shaped conductor 2 and the columnar conductor 4 are fixed integrally in contact with each other by a plurality of screws (not shown).

The state in which the columnar conductor 4 and the first plate-shaped conductor 2 are electrically connected to each other includes a case where the columnar conductor 4 and the first plate-shaped conductor 2 are electrically conductive to each other by direct contact therebetween or via another conductor, and a case where the columnar conductor 4 and the first plate-shaped conductor 2 are connected in a high-frequency manner via capacitive coupling therebetween. The same applies to connection between conductors in the following description.

The end surface 19 contacts with the end surface 13a2 of the insulation member 13a. Thus, the columnar conductor 4 and the ground conductor 10 are not electrically connected to each other.

As shown in FIG. 3, a distal end hole 17 opens at the end surface 19. The distal end hole 17 is a cylindrical hole provided along the Z direction. The pin 12 is inserted into the distal end hole 17. The inner circumferential surface of the distal end hole 17 and the outer circumferential surface of the pin 12 contact with each other. Thus, the columnar conductor 4 and the pin 12 are electrically connected to each other.

The pin 12 is electrically connected to the inner conductor of the coaxial cable. Therefore, an opening end edge 19a of the distal end hole 17 at the end surface 19 is a feeding point.

The columnar conductor 4 has a hole 21. The hole 21 is a cylindrical hole provided along the Z direction. The hole 21 opens at the base end surface 18.

The hole 21 has a small-diameter portion 21a and a large-diameter portion 21b. The small-diameter portion 21a and the large-diameter portion 21b are connected coaxially with each other. The small-diameter portion 21a is provided on the distal end 16 side. The large-diameter portion 21b is provided on the base end surface 18 side.

The hole 21 and the distal end hole 17 are connected coaxially with each other. That is, the distal end hole 17 and the hole 21 penetrate the columnar conductor 4 along the Z direction.

As shown in FIG. 3, the pin 12 inserted in the distal end hole 17 protrudes to the inside of the hole 21. The pin 12 and the columnar conductor 4 are joined to each other by a welding member (not shown) formed by solder or brazing, for example.

The shape of the hole 21 of the columnar conductor 4 is not particularly limited.

The hole 21 of the columnar conductor 4 may be used as a working space when the welding member for joining the pin 12 and the columnar conductor 4 is formed.

In this case, it is preferable that the inner diameter of the hole 21 is as large as possible, in terms of workability. In order to make the inner diameter of the inner diameter of the hole 21 as large as possible, it is conceivable that the inner circumferential surface of the hole 21 is formed so that the diameter thereof gradually expands from the distal end 16 side toward the base end surface 18 side along the shape of the side surface 20.

However, in this case, the cost needed for forming the hole 21 can increase.

Accordingly, in the present embodiment, the hole 21 is formed by the small-diameter portion 21a and the large-diameter portion 21b. Thus, it is possible to make the inner diameter of the hole 21 comparatively large by the large-diameter portion 21b, while reducing the cost needed for forming the hole 21.

The shape of the columnar conductor 4 is a solid-of-revolution shape. A revolution axis S of the solid-of-revolution shape of the columnar conductor 4 is a line perpendicular to the plate surface 2a and along the Z direction. The revolution axis S passes through the center of the distal end hole 17. Thus, the contour shape of a cross-section of the columnar conductor 4 along X-Y plane is a circular shape.

Therefore, the side surface 20 of the columnar conductor 4 has a side surface shape of the solid-of-revolution shape. The shape of the side surface 20 will be described later in detail.

The first plate-shaped conductor 2 extends in a band shape along the X direction, as described above.

The columnar conductor 4 is provided on a first end 2b side (the X2 direction side of the first plate-shaped conductor 2) in the longitudinal direction of the first plate-shaped conductor 2.

That is, the first end 2b side of the first plate-shaped conductor 2 is electrically connected to the columnar conductor 4 having the feeding point.

Therefore, a second end 2c side of the first plate-shaped conductor 2 is an open end.

The second end 2c is an end opposite to the first end 2b in the longitudinal direction of the first plate-shaped conductor 2.

The longitudinal direction of the first plate-shaped conductor 2 is the extending direction of the first plate-shaped member 2 having a band shape, and is a direction along the X direction.

As shown in FIG. 1, a short-side portion 2cl on the second end 2c side of the first plate-shaped conductor 2 is an end surface along the Y direction, and is a flat surface parallel to Y-Z plane.

On the other hand, a short-side portion 2b1 on the first end 2b side in the longitudinal direction of the first plate-shaped conductor 2 has a curved surface contiguous to the side surface 20 with no step therebetween. The short-side portion 2b1 may be a curved surface parallel to the Z direction and along the side surface 20 on X-Y plane. In this case, there is an advantage in terms of ease of manufacturing and cost. In addition, in this case, the short-side portion 2b1 might slightly protrude or be slightly recessed relative to the side surface 20. However, this protrusion or recess is extremely small and therefore the influence on an effect of making change in the characteristic impedance mild as described later is small.

A pair of long-side portions 2d1 of the first plate-shaped conductor 2 are end surfaces along the X direction and are flat surfaces parallel to X-Z plane.

A width dimension along the Y direction of the first plate-shaped conductor 2 is substantially the same as a width dimension along the Y direction of the base end surface 18. The base end surface 18 is also considered a cross-section of the columnar conductor 4 along the plate surface 2a.

The first plate-shaped conductor 2 has a function as a capacitance loading plate for the columnar conductor 4. Therefore, instead of a band-shaped member as in the present embodiment, a plate-shaped member having a larger area can also be used.

However, as in the present embodiment, using the first plate-shaped conductor 2 having a band shape makes it possible to, while maintaining the characteristic of the antenna 1, reduce the size of the antenna 1 as seen in a plan view, thus achieving size reduction of the antenna 1.

In addition, since the width dimension of the first plate-shaped conductor 2 is the same as the width dimension of the base end surface 18 of the columnar conductor 4, the size of the antenna 1 as seen in a plan view can be more reduced.

Further, in the present embodiment, since the short-side portion 2b1 on the first end 2b side of the first plate-shaped conductor 2 has a shape along the contour shape of the base end surface 18, the size of the antenna 1 as seen in a plan view can be even more reduced.

The short-circuit conductor 6 is a cylindrical member provided at the plate surface 2a of the first plate-shaped conductor 2 so as to protrude therefrom.

As shown in FIG. 3, the short-circuit conductor 6 is provided with a predetermined interval from the columnar conductor 4.

The short-circuit conductor 6 has a conductor body 6a and a spacer 6b.

The conductor body 6a is a long-sized screw made of a conductor such as copper, steel for mechanical structure, or alloy steel. The spacer 6b is a cylindrical member made of a conductor or an insulation material such as resin.

The spacer 6b is placed between the first plate-shaped conductor 2 and the ground conductor 10.

The first plate-shaped conductor 2 and the ground conductor 10 respectively have a hole 2e and a hole 10d for attaching the short-circuit conductor 6.

The spacer 6b is placed along the Z direction. At this time, an inner circumferential hole of the spacer 6b coincides with the hole 2e of the first plate-shaped conductor 2 and the hole 10d of the ground conductor 10. The length of the spacer 6b is set to be substantially the same as the length in the Z direction of the columnar conductor 4.

Both end surfaces of the spacer 6b contact with the first plate-shaped conductor 2 and the ground conductor 10. Thus, the spacer 6b positions the interval between the first plate-shaped conductor 2 and the ground conductor 10.

The conductor body 6a is inserted through the hole 2e, the spacer 6b, and the hole 10d. A nut 7 is attached to a screw portion at the distal end of the conductor body 6a.

By tightening the nut 7, the first plate-shaped conductor 2, the spacer 6b, and the ground conductor 10 are tightened between the nut 7 and a screw head 6a1 of the conductor body 6a.

Thus, a weight load applied to the distal end 16 of the columnar conductor 4 connecting to the ground conductor 10 can be reduced, and the antenna 1 is firmly retained.

In FIG. 2B, the screw head 6a1 is not shown.

A washer 8 made of a conductor is interposed between the screw head 6a1 and the first plate-shaped conductor 2.

A washer 9 made of a conductor is also interposed between the nut 7 and the ground conductor 10.

Thus, the short-circuit conductor 6 electrically connects the first plate-shaped conductor 2 and the ground conductor 10, so as to ground the first plate-shaped conductor 2.

In this case, the input impedance of the antenna 1 can be appropriately adjusted by the short-circuit conductor 6, whereby the antenna 1 can be adapted to a wider frequency band.

### Side Surface 20 of Columnar Conductor 4

The side surface 20 of the columnar conductor 4 has a taper shape tapered from the first plate-shaped conductor 2 side toward the distal end 16 side, as described above. In the present embodiment, the taper shape refers to a shape in which the side surface 20 is tapered from the first plate-shaped conductor 2 side toward the distal end 16 side as a whole.

Even in a case of partially having a protrusion or a recess, any shape in which the side surface 20 is tapered from the first plate-shaped conductor 2 side toward the distal end 16 side as a whole is regarded as a taper shape.

The side surface 20 has a smooth convex curved shape.

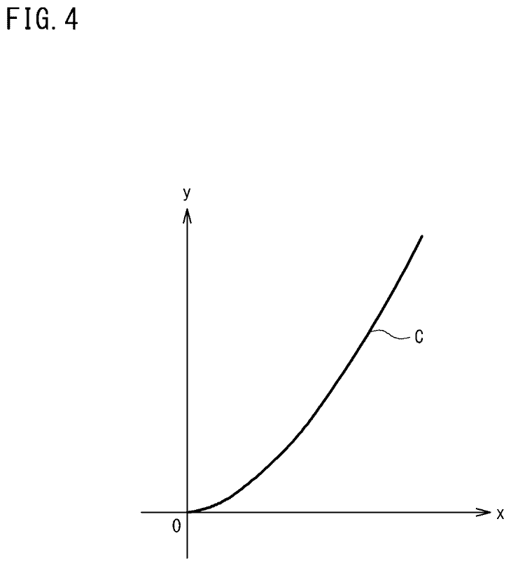

FIG. 4 is a graph showing a contour curve of the side surface 20 in a cross-section of the columnar conductor 4 along a plane including the revolution axis S.

In FIG. 4, a contour curve C is shown with the revolution axis S defined as a y axis, and a line perpendicular to the revolution axis S at the end surface 19 defined as an x axis.

The contour curve C shown in FIG. 4 satisfies the following Formula (1).

$$y = a {x}^{P} \qquad ( 1 )$$

Here, x≥0, a>0, and P≥1.

The columnar conductor 4 of the present embodiment has the side surface 20 having the contour curve satisfying the above Formula (1). Therefore, the area of the base end surface 18 (the sectional area of the cross-section of the columnar conductor 4 along the plate surface 2a) is larger than the area of the end surface 19 of the distal end 16.

In this case, the contour length of the base end surface 18 and the contour length of the end surface 19 are different from each other.

Meanwhile, the side surface 20 is tapered in a taper shape from the first plate-shaped conductor 2 side toward the distal end 16 side.

In other words, the columnar conductor 4 of the present embodiment has the side surface 20 having the contour curve satisfying the above Formula (1), thereby having such a shape that the sectional area of the cross-section of the columnar conductor 4 along a plane parallel to the plate surface 2a gradually decreases from the first plate-shaped conductor 2 side toward the distal end 16 side.

With this configuration, the first plate-shaped conductor 2 functions as a capacitance loading plate, and thus it is possible to adapt to a signal in a comparatively low frequency band of, for example, 1 GHz or lower, while achieving a low profile.

Further, since the columnar conductor 4 has a shape having the taper-shaped side surface 20 tapered from the first plate-shaped conductor 2 side toward the distal end 16 side, the contour of the base end surface 18 and the contour of the end surface 19 having different lengths can be smoothly connected. Accordingly, change in the characteristic impedance of the columnar conductor 4 over a range to the first plate-shaped conductor 2 from the distal end 16 having a feeding point can be made mild. Thus, it is possible to reduce return loss of the antenna 1 with respect to a signal in a comparatively high frequency band of several GHz or more, e.g., SUB-6.

Thus, it is possible to obtain the antenna 1 that is adaptable to a wide frequency band while achieving a low profile.

It is preferable that the height of the antenna 1 is approximately 0.07 times the wavelength in a comparatively low frequency band of 1 GHz or lower, of adaptable frequency bands of the antenna 1.

For example, in a case where the adaptable frequency band of the antenna 1 includes 800 MHz, the wavelength is about 380 mm, and therefore it is preferable that the height of the antenna 1 is about 27 mm.

Further, since the side surface 20 is a convex curved surface and the contour curve of the side surface 20 satisfies the above formula, it is possible to adjust change in the characteristic impedance of the columnar conductor 4 more appropriately.

The contour curve of the side surface 20 is a curve for satisfying the shape of the side surface 20 as a whole. Therefore, even in a case where the side surface 20 partially has a protrusion or a recess, the contour curve of the side surface 20 is regarded as satisfying the above formula as long as the contour curve representing the shape of the side surface 20 as a whole satisfies the above formula.

In the present embodiment, since the columnar conductor 4 is provided on the first end 2b side of the first plate-shaped conductor 2, the size can be made compact and a distance from the second end 2c of the first plate-shaped conductor 2 to the columnar conductor 4 can be appropriately ensured, whereby a low profile can be more easily achieved.

In the present embodiment, the case of obtaining the antenna 1 by assembling the first plate-shaped conductor 2 and the columnar conductor 4 has been shown. However, the antenna 1 may be obtained by integrally forming the first plate-shaped conductor 2 and the columnar conductor 4.

In the above first embodiment, the case of integrally forming the columnar conductor 4 has been shown. However, as in a second embodiment described below, the columnar conductor 4 may be formed by combining a plurality of divisional bodies.

### Second Embodiment

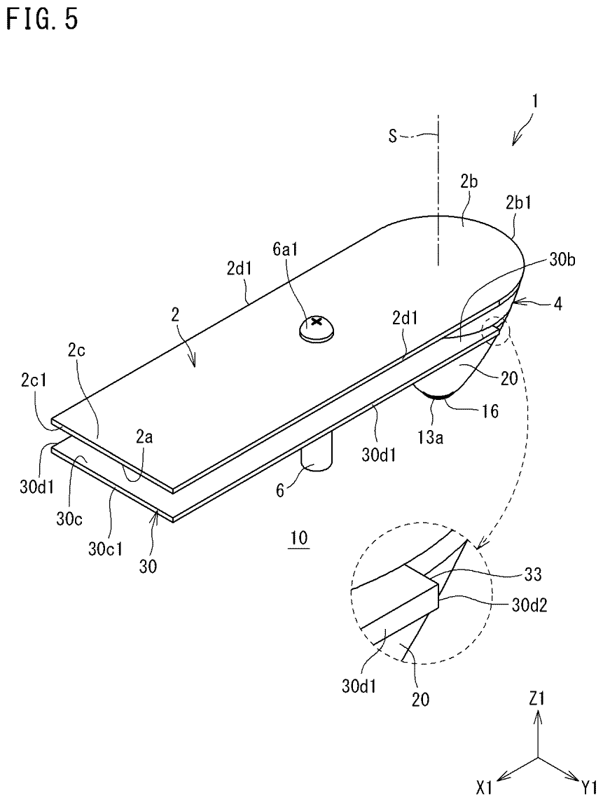

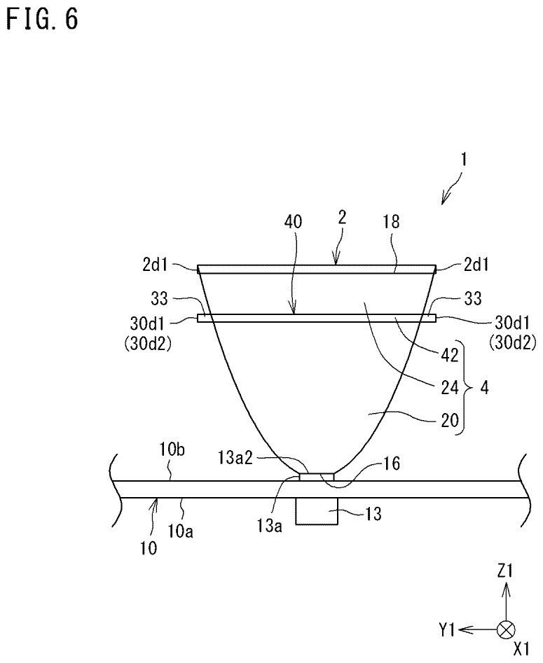

FIG. 5 is a perspective view of the antenna 1 according to a second embodiment, and FIG. 6 is a side view of the antenna 1 according to the second embodiment. In FIG. 6, the screw head 6a1 is not shown.

The present embodiment is different from the first embodiment in that the antenna 1 has a second plate-shaped conductor 30.

The second plate-shaped conductor 30 is provided at the side surface 20 of the columnar conductor 4 so as to protrude therefrom, and is located so as to be opposed to the first plate-shaped conductor 2. The second plate-shaped conductor 30 is located between the first plate-shaped conductor 2 and the ground conductor 10.

The second plate-shaped conductor 30 has a plate shape along X-Y plane. Therefore, the second plate-shaped conductor 30 and the ground conductor 10 are parallel to each other. The second plate-shaped conductor 30 extends in a band shape along the X direction.

As shown in FIG. 5, a third end 30b in the longitudinal direction of the second plate-shaped conductor 30 connects to the side surface 20 of the columnar conductor 4.

On the other hand, a short-side portion 30cl on a fourth end 30c side of the second plate-shaped conductor 30 is an end surface along the Y direction, and is a flat surface parallel to Y-Z plane.

A pair of long-side portions 30d1 of the second plate-shaped conductor 30 are end surfaces along the X direction, and are flat surfaces parallel to X-Z plane.

The position in the X direction of the short-side portion 30cl of the second plate-shaped conductor 30 and the position in the X direction of the short-side portion 2cl of the first plate-shaped conductor 2 are the same.

The positions in the Y direction of the pair of long-side portions 30d1 of the second plate-shaped conductor 30 and the positions in the Y direction of the pair of long-side portions 2d1 of the first plate-shaped conductor 2 are the same. Therefore, the width dimension along the Y direction of the second plate-shaped conductor 30 and the width dimension along the Y direction of the first plate-shaped conductor 2 are the same.

Thus, a shape when the pair of long-side portions 30d1 and the short-side portion 30cl of the second plate-shaped conductor 30 are projected on X-Y plane and a shape when the pair of long-side portions 2d1 and the short-side portion 2cl of the first plate-shaped conductor 2 are projected on X-Y plane, coincide with each other.

The pair of long-side portions 30d1 of the second plate-shaped conductor 30 extend to the position of the revolution axis S in the X direction.

The diameter of the columnar conductor 4 at a position in the Z direction where the second plate-shaped conductor 30 is located is smaller than the diameter of the base end surface 18. Therefore, an end edge 30d2 on the X2 direction side of the long-side portion 30d1 protrudes relative to the side surface 20. Thus, the third end 30b of the second plate-shaped conductor 30 has a pair of end flat-surface portions 33 on both sides of the columnar conductor 4.

As shown in FIG. 5 and FIG. 6, the pair of end flat-surface portions 33 are surfaces facing in the X2 direction. The pair of end flat-surface portions 33 are flat surfaces parallel to Y-Z plane.

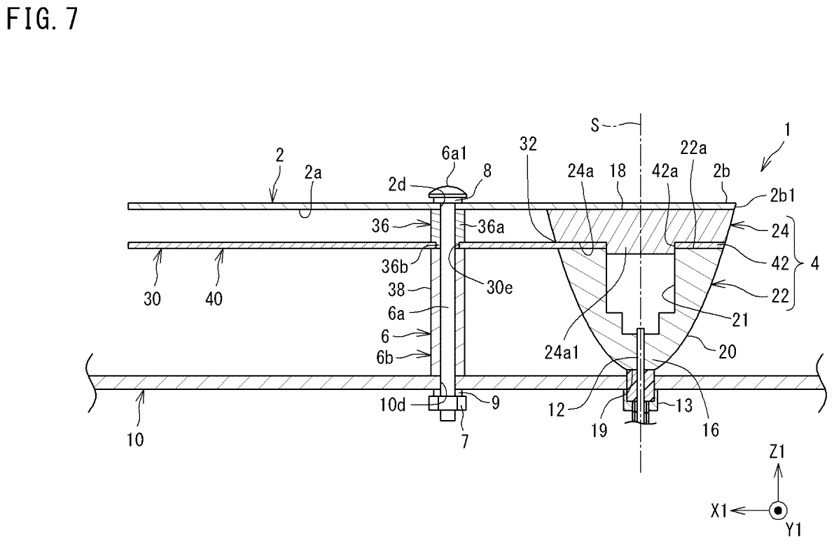

FIG. 7 is a sectional view of the antenna 1 according to the second embodiment along X-Z plane. FIG. 7 shows a cross-section passing through the Y-direction center of the antenna 1.

As shown in FIG. 7, the columnar conductor 4 includes a first divisional body 22 and a second divisional body 24.

The first divisional body 22 is a member formed by a conductor such as copper.

The first divisional body 22 includes the distal end 16 described above. In addition, the first divisional body 22 includes the hole 21.

The hole 21 opens at a contact surface 22a. The contact surface 22a is a surface that the first divisional body 22 has and is opposite to the end surface 19.

The second divisional body 24 is a member formed by a conductor such as copper.

The second divisional body 24 includes the base end surface 18. The second divisional body 24 has, at a contact surface 24a, a protrusion 24a1 fitted to the hole 21. The contact surface 24a is a surface that the second divisional body 24 has and is opposite to the base end surface 18. The first divisional body 22 and the second divisional body 24 are positioned relative to each other by the protrusion 24a1.

As shown in FIG. 7, a plate member 40 is fixed by being held between the first divisional body 22 and the second divisional body 24.

The plate member 40 includes the second plate-shaped conductor 30 described above, and the interposed portion 42. The interposed portion 42 is a part interposed between the first divisional body 22 and the second divisional body 24. The interposed portion 42 forms a part of the columnar conductor 4.

When the plate member 40 is fixed between the first divisional body 22 and the second divisional body 24, a part protruding from the columnar conductor 4, of the plate member 40, is the second plate-shaped conductor 30.

That is, of the plate member 40, a part on the X1 direction side from a boundary portion 32 in FIG. 7 is the second plate-shaped conductor 30. Of the plate member 40, a part on the X2 direction side from the boundary portion 32 is the interposed portion 42.

As described above, the columnar conductor 4 of the present embodiment is formed by the first divisional body 22, the second divisional body 24, and the interposed portion 42.

The plated-shaped interposed portion 42 is held between the contact surface 22a and the contact surface 24a. Thus, the first divisional body 22 and the interposed portion 42 contact with each other. The interposed portion 42 and the second divisional body 24 contact with each other. Therefore, the first divisional body 22, the second divisional body 24, and the interposed portion 42 are electrically connected to each other.

Thus, the second plate-shaped conductor 30 and the columnar conductor 4 are electrically connected to each other.

An end surface of the interposed portion 42 that faces in the X2 direction has a curved surface contiguous to the side surface 20 with no step therebetween. The end surface of the interposed portion 42 that faces in the X2 direction may be a curved surface parallel to the Z direction and along the side surface 20 on X-Y plane, as with the short-side portion 2b1 of the first plate-shaped conductor 2.

The interposed portion 42 has a hole 42a. The protrusion 24a1 is inserted into the hole 42a. Thus, the interposed portion 42 (plate member 40) is positioned relative to the first divisional body 22 and the second divisional body 24.

The first divisional body 22, the second divisional body 24, and the interposed portion 42 are combined with each other and are integrally fixed with the first plate-shaped conductor 2 by a screw (not shown) or the like.

Fixation of the first divisional body 22 and the second divisional body 24 is performed after the pin 12 and the first divisional body 22 are joined to each other.

The reason therefor is that the hole 21 of the first divisional body 22 can be used as a working space when the welding member for joining the pin 12 and the first divisional body 22 is formed, as described above.

The second plate-shaped conductor 30 has a hole 30e through which the conductor body 6a of the short-circuit conductor 6 is inserted.

The conductor body 6a is inserted into the hole 2e, the hole 30e, the spacer 6b, and the hole 10d.

The spacer 6b includes a first body portion 36 and a second body portion 38. The first body portion 36 and the second body portion 38 are cylindrical members made of an insulator such as resin.

The second body portion 38 is placed between the ground conductor 10 and the second plate-shaped conductor 30. Both end surfaces of the second body portion 38 contact with the second plate-shaped conductor 30 and the ground conductor 10. Thus, the second body portion 38 positions the interval between the second plate-shaped conductor 30 and the ground conductor 10.

The first body portion 36 is placed between the first plate-shaped conductor 2 and the second plate-shaped conductor 30.

The first body portion 36 has a large-diameter portion 36a and a small-diameter portion 36b. The small-diameter portion 36b is provided at one end surface of the large-diameter portion 36a so as to protrude therefrom.

The small-diameter portion 36b is inserted into the hole 30e of the second plate-shaped conductor 30. The small-diameter portion 36b is interposed between the conductor body 6a and the second plate-shaped conductor 30. Thus, the conductor body 6a and the second plate-shaped conductor 30 are insulated from each other.

Both end surfaces of the large-diameter portion 36a contact with the first plate-shaped conductor 2 and the second plate-shaped conductor 30. Thus, the large-diameter portion 36a positions the interval between the first plate-shaped conductor 2 and the second plate-shaped conductor 30.

As described above, the antenna 1 of the present embodiment includes the second plate-shaped conductor 30 provided at the side surface 20 of the columnar conductor 4 so as to protrude therefrom and located on the plate surface 2a side of the first plate-shaped conductor 2 so as to be opposed to the first plate-shaped conductor 2.

Thus, the antenna 1 can be configured with two elements and can have a wide band owing to increase in the resonance frequency.

In the present embodiment, the case of obtaining the antenna 1 by assembling the first plate-shaped conductor 2, the plate member 40, the first divisional body 22, and the second divisional body 24 has been shown. However, the antenna 1 may be obtained by integrally forming the first plate-shaped conductor 2, the second plate-shaped conductor 30, and the columnar conductor 4.

In the present embodiment, the case where the shape when the second plate-shaped conductor 30 is projected on X-Y plane and the shape when the first plate-shaped conductor 2 is projected on X-Y plane coincide with each other, has been shown.

However, the shape when the second plate-shaped conductor 30 is projected on X-Y plane and the shape when the first plate-shaped conductor 2 is projected on X-Y plane may not necessarily coincide with each other. Another plate-shaped conductor may be provided in addition to the first plate-shaped conductor 2 and the second plate-shaped conductor 30. In this case, the other plate-shaped conductor is provided so as to protrude from the side surface 20 of the columnar conductor 4. At this time, the other plate-shaped conductor is provided with predetermined intervals in the Z direction from the first plate-shaped conductor 2 and the second plate-shaped conductor 30.

The first plate-shaped conductor 2 and the plate member 40 may have completely the same shape. In this case, the first plate-shaped conductor 2 can be used as not only the first plate-shaped conductor 2 but also the plate member 40. Thus, it becomes possible to reduce the cost owing to the effect of mass production.

In the case of using the first plate-shaped conductor 2 as the plate member 40, an end edge of the plate member 40 (an end edge of the first end 2b of the first plate-shaped conductor 2 when used as the plate member 40) protrudes from the side surface 20 of the columnar conductor 4. However, the side surface 20 can be considered a shape tapered from the first plate-shaped conductor 2 side toward the distal end 16 side as a whole, and therefore no significant influence arises.

### Third Embodiment

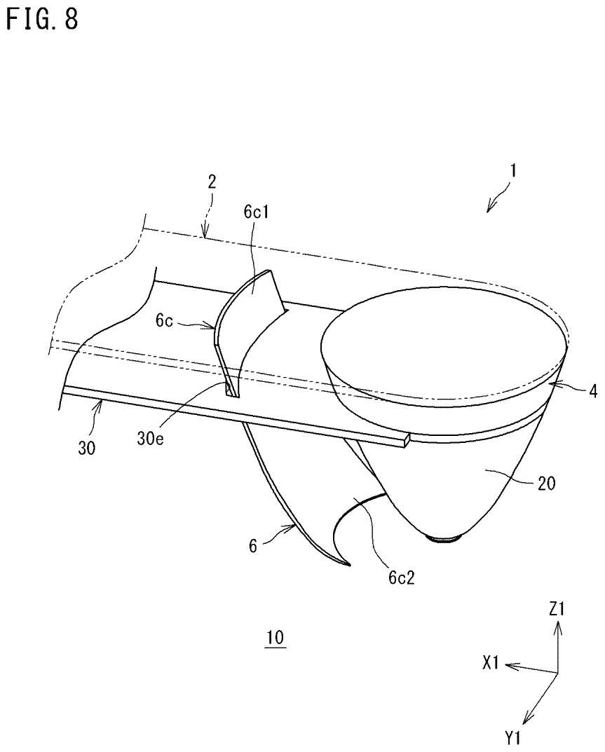

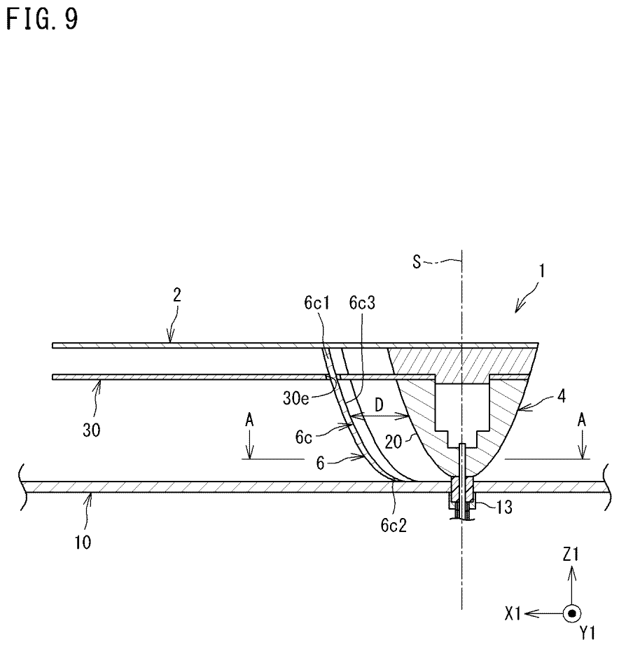

FIG. 8 is a perspective view of the antenna 1 according to the third embodiment, and FIG. 9 is a sectional view of the antenna 1 according to the third embodiment along X-Z plane. In FIG. 8, for facilitating the understanding, the first plate-shaped conductor 2 is shown by a virtual line (two-dot dashed line). FIG. 9 shows a cross-section passing through the Y-direction center of the antenna 1.

The present embodiment is different from a second embodiment in that the short-circuit conductor 6 has a plate shape.

The short-circuit conductor 6 of the present embodiment has a body member 6c obtained by forming a conductor such as copper into a plate shape.

A fifth end 6cl of the body member 6c is fixed in contact with the first plate-shaped conductor 2. Thus, the body member 6c and the first plate-shaped conductor 2 are electrically connected to each other.

A sixth end 6c2 of the body member 6c is fixed in contact with the ground conductor 10. Thus, the body member 6c and the ground conductor 10 are electrically connected to each other.

Therefore, the body member 6c grounds the first plate-shaped conductor 2.

The body member 6c has a plate shape curved in accordance with the side surface 20 of the columnar conductor 4, and is located so as to be opposed to the side surface 20 of the columnar conductor 4 with a predetermined interval therebetween.

As shown in FIG. 8, the hole 30e of the second plate-shaped conductor 30 has a hole shape curved in accordance with the shape of the body member 6c.

A gap is provided between the body member 6c and the hole 30e. Thus, the body member 6c and the second plate-shaped conductor 30 are insulated from each other.

As shown in FIG. 9, in a cross-section including a diameter of the columnar conductor 4, an interval D along the radial direction between a first surface 6c3 of the body member 6c and the side surface 20 of the columnar conductor 4 is constant in the Z direction.

That is, the body member 6c has a curved shape along a side surface formed when the radius of the columnar conductor 4 is expanded by D.

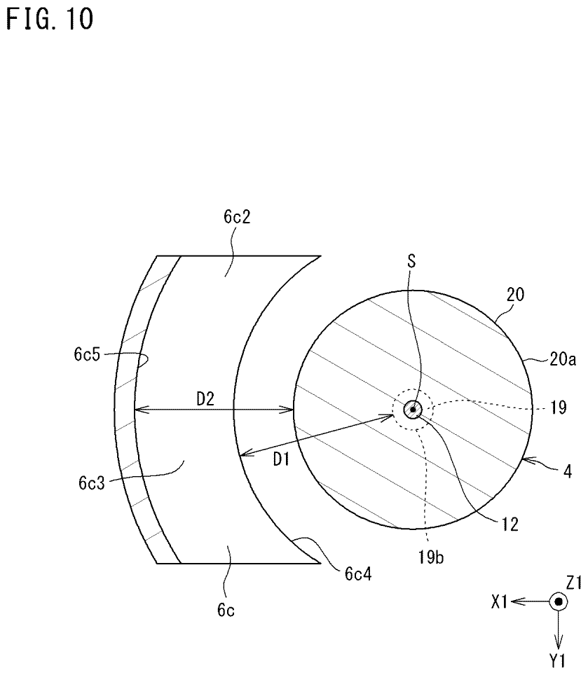

FIG. 10 is a sectional view as seen in A-A arrow direction in FIG. 9.

In FIG. 10, an interval along the radial direction between a contour line 19b and an end edge 6c4 is defined as D1, and an interval along the radial direction between a contour line 20a and a contour line 6c5 is defined as D2.

The contour line 19b is a contour line of the end surface 19.

The end edge 6c4 is an end edge of the sixth end 6c2 of the body member 6c. The end edge 6c4 is an arc centered at the revolution axis S. The end edge 6c4 and the contour line 19b are at the same position in the Z direction.

Here, in the case where the insulation member 13a slightly protrudes from the second surface 10b of the ground conductor 10 as in the present embodiment, the position in the Z direction of the end edge 6c4 and the position in the Z direction of the contour line 19b might be slightly displaced from each other. In this case, position adjustment for the body member 6c and the columnar conductor 4 is performed so that the position in the Z direction of the end edge 6c4 and the position in the Z direction of the contour line 19b coincide with each other.

Here, for facilitating the understanding, it is assumed that the position in the Z direction of the end edge 6c4 and the position in the Z direction of the contour line 19b are the same.

The contour line 20a is a contour line of the side surface 20 in a cross-section of the columnar conductor 4 in FIG. 10.

The contour line 6c5 is a contour line of the first surface 6c3 in a cross-section of the body member 6c in FIG. 10. The contour line 6c5 is an arc centered at the revolution axis S.

In FIG. 10, the interval D1 and the interval D2 are the same value D.

Thus, the interval D along the radial direction between the body member 6c and the columnar conductor 4 is the same value irrespective of a position in the Z direction and a position in the circumferential direction around the revolution axis S.

Thus, the body member 6c has a curved shape along a side surface formed when the radius of the columnar conductor 4 is expanded by D.

In the present embodiment, the short-circuit conductor 6 curved in accordance with the side surface 20 of the columnar conductor 4 is located so as to be opposed to the side surface 20 with the interval D therebetween, whereby a comparatively low frequency band of adaptable frequency bands can be made wide.

### Fourth Embodiment

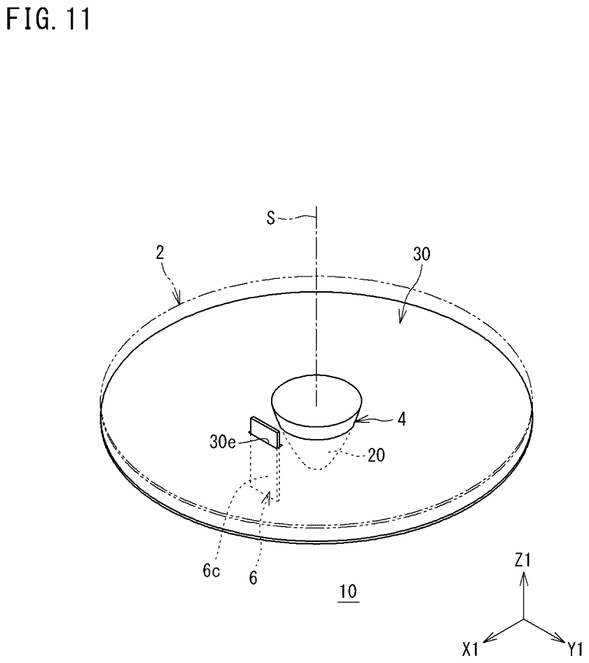

FIG. 11 is a perspective view of the antenna 1 according to the fourth embodiment. In FIG. 11, for facilitating the understanding, the first plate-shaped conductor 2 is shown by a virtual line (two-dot dashed line).

The present embodiment is different from the second embodiment and the third embodiment in that the first plate-shaped conductor 2 and the second plate-shaped conductor 30 have circular shapes and the body member 6c of the short-circuit conductor 6 has a rectangular plate shape.

As shown in FIG. 11, the first plate-shaped conductor 2 and the second plate-shaped conductor 30 have circular shapes centered at the revolution axis S. Therefore, the columnar conductor 4 is provided at the centers of the first plate-shaped conductor 2 and the second plate-shaped conductor 30.

The body member 6c of the short-circuit conductor 6 is formed in a plate shape along Y-Z plane. The body member 6c extends along the Z direction.

The hole 30e of the second plate-shaped conductor 30 through which the body member 6c is inserted is formed in a rectangular shape in accordance with the shape of the body member 6c.

Also in the present embodiment, a gap is provided between the body member 6c and the hole 30e. Thus, the body member 6c and the second plate-shaped conductor 30 are insulated from each other.

### Fifth Embodiment

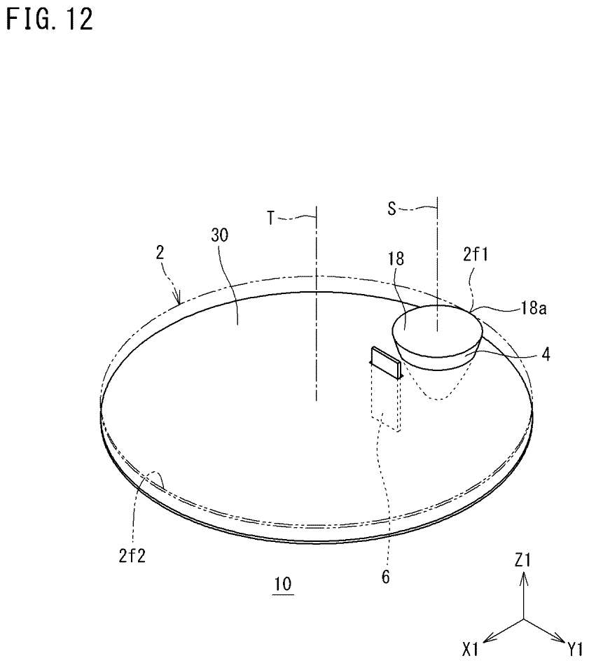

FIG. 12 is a perspective view of the antenna 1 according to the fifth embodiment. In FIG. 12, for facilitating the understanding, the first plate-shaped conductor 2 is shown by a virtual line (two-dotted dashed line).

The present embodiment is different from the fourth embodiment in that the revolution axis S of the columnar conductor 4 and a center axis T of the first plate-shaped conductor 2 and the second plate-shaped conductor 30 do not coincide with each other.

As shown in FIG. 12, the columnar conductor 4 of the present embodiment is provided at a position shifted in the X2 direction from the center axis T.

An end edge 18a of the base end surface 18 of the columnar conductor 4 coincides with an end edge 2f1 of the first plate-shaped conductor 2. That is, the columnar conductor 4 is provided at an endmost part of the first plate-shaped conductor 2.

As described above, since the columnar conductor 4 is provided at a position shifted from the center axis T of the first plate-shaped conductor 2, a distance on the first plate-shaped conductor 2 from the columnar conductor 4 to another end edge 2f2 across the center axis T can be ensured as necessary, whereby it is possible to favorably adapt to a signal in a comparatively low frequency band.

Also in the first to third embodiments, the columnar conductor 4 is provided between the center of the first plate-shaped conductor 2 and the end edge of the first plate-shaped conductor 2. The center in this case is, for example, the center of gravity of the contour shape of the first plate-shaped conductor 2.

### MODIFICATIONS

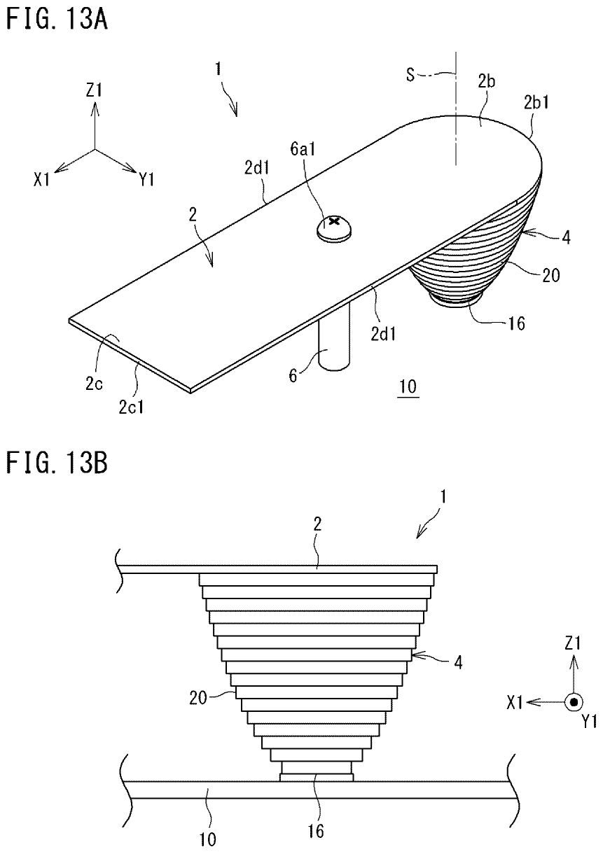

In the above embodiments, the case where the side surface 20 of the columnar conductor 4 is a smooth curved surface has been shown. However, as shown in FIG. 13A and FIG. 13B, the side surface 20 may have a step shape expanding stepwise from the end surface 19 side toward the first plate-shaped conductor 2 side.

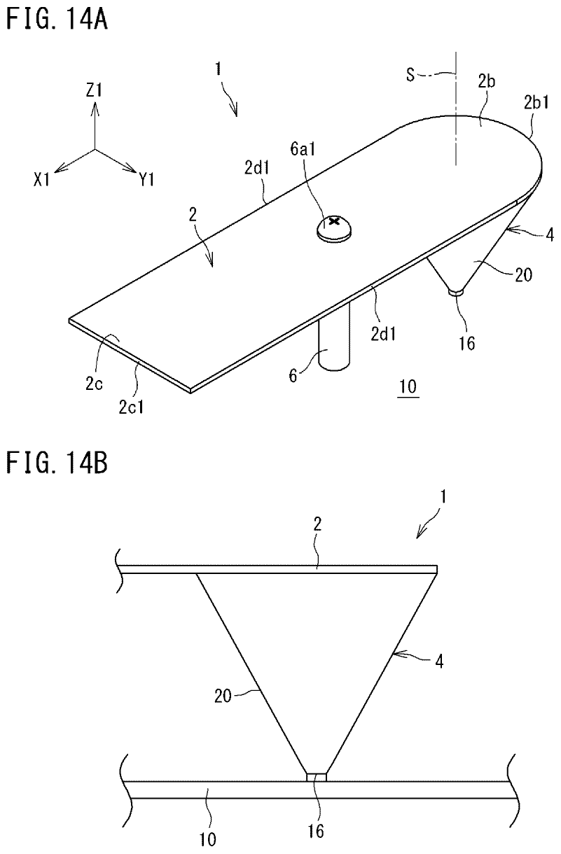

As shown in FIG. 14A and FIG. 14B, the side surface 20 may be formed as a conical surface.

Also in these cases, change in the characteristic impedance of the columnar conductor 4 can be made mild as in the case of having a smooth curved surface.

In the above embodiments, the case where the side surface 20 of the columnar conductor 4 has a solid-of-revolution shape and the contour shape of the cross-section of the columnar conductor 4 along X-Y plane is a circular shape, has been shown. However, the cross-section contour shape of the columnar conductor 4 along X-Y plane may be an oblong shape, an elliptic shape, or a polygonal shape.

In the above embodiments, the case where the columnar conductor 4 (first divisional body 22 and second divisional body 24) is formed by a conductor has been shown. However, the columnar conductor 4 may include a body portion formed by resin or the like and a conductor coat formed on the surface of the body portion, for example.

In the above embodiments, the case where the first plate-shaped conductor 2 has a band shape or a circular shape has been shown. However, the first plate-shaped conductor 2 may be a polygonal shape such as a triangular shape or a pentagonal shape, an oblong shape, or an elliptic shape.

In the above embodiments, the case where the center of the first plate-shaped conductor 2 is set as the center of gravity of the contour shape of the first plate-shaped conductor 2 as seen in a plan view and the position of the columnar conductor 4 is determined with the center of the first plate-shaped conductor 2 which is the center of gravity as a reference, has been shown.

On the other hand, in a case where the first plate-shaped conductor 2 has a polygonal shape, the center of the first plate-shaped conductor 2 may be set as the center of a circumscribed circle of the contour shape of the first plate-shaped conductor 2, and the position of the columnar conductor 4 may be determined with the center as a reference.

The center of gravity of the first plate-shaped conductor 2 and the center of the circumscribed circle of the contour shape of the first plate-shaped conductor 2 can be favorably used as the center of the first plate-shaped conductor 2.

In the above embodiments, the case of providing one short-circuit conductor 6 has been shown. However, a plurality of the short-circuit conductors 6 may be provided. In this case, the weight load applied to the distal end 16 of the columnar conductor 4 connecting to the ground conductor 10 can be more reduced and the antenna 1 can be more firmly retained.

### Verification Test 1

Next, a verification test 1 conducted regarding the effects of the antenna 1 will be described.

The test method is as follows. A model of the antenna 1 was created, and using the model, a frequency characteristic (frequency characteristic of S-parameter S11) of return loss of the antenna 1 was calculated through simulation by a computer.

In the verification test 1, one Comparative example and five Examples shown below were test targets, and the calculated frequency characteristics of return loss were compared with each other, thus conducting verification of the effects of the antenna 1.

### Example 1

The antenna 1 described in the first embodiment was created as a model in Example 1.

The dimensions of parts of the first plate-shaped conductor 2 were set as follows.
Width dimension (dimension in Y direction): 30 mm
Length dimension (dimension in X direction): 95 mm
Plate thickness: 1 mm

The dimensions of parts of the columnar conductor 4 were set as follows.
Height dimension (dimension in Z direction): 26 mm
Dimension of base end surface 18: 30 mm
In above Formula (1), a=1, P=1.7

The width dimension (dimension in Y direction) of the antenna 1 was 30 mm, the length dimension (dimension in Y direction) of the antenna 1 was 95 mm, and the height dimension (dimension in Z direction) of the antenna 1 was 27 mm.

The diameter of the conductor body 6a of the short-circuit conductor 6 was set at 2.5 mm.

A distance in the X direction between the center axis of the columnar conductor 4 and the center axis of the short-circuit conductor 6 was set at 30 mm.

### Example 2

The antenna 1 described in the second embodiment was created as a model in Example 2.

That is, in Example 2, the antenna 1 obtained by adding the second plate-shaped conductor 30 to Example 1 was verified.

The width dimension in the Y direction of the second plate-shaped conductor 30 was set at 30 mm.

The plate thickness of the second plate-shaped conductor 30 was set at 1 mm.

The other dimensions were the same as in Example 1.

### Example 3

The antenna 1 described in the third embodiment was created as a model in Example 3.

That is, in Example 3, the antenna 1 obtained by making the short-circuit conductor 6 in Example 2 into a plate shape was verified.

The short-circuit conductor 6 in Example 3 has a plate shape curved in accordance with the side surface 20 of the columnar conductor 4.

The width dimension in the Y direction of the fifth end 6cl of the short-circuit conductor 6 was set at 20 mm.

A distance in the X direction between the revolution axis S and the center in the X direction and the Y direction of the fifth end 6cl was set at 30 mm.

The other dimensions were the same as in Example 2.

### Example 4

The antenna 1 described in the fourth embodiment was created as a model in Example 4.

That is, in Example 4, the antenna 1 in which the first plate-shaped conductor 2 and the second plate-shaped conductor 30 have circular shapes was verified.

The diameters of the first plate-shaped conductor 2 and the second plate-shaped conductor 30 were set at 70 mm.

The width dimension in the Y direction of the short-circuit conductor 6 having a rectangular plate shape was set at 10 mm.

The distance in the X direction between the short-circuit conductor 6 and the revolution axis S were set at 30 mm.

The other dimensions were the same as in Example 2.

### Example 5

The antenna 1 described in the fifth embodiment was created as a model in Example 5.

In Example 5, the antenna 1 in which the revolution axis S of the columnar conductor 4 and the center axis T of the first plate-shaped conductor 2 and the second plate-shaped conductor 30 did not coincide with each other in Example 4 was verified.

The antenna 1 in Example 5 is the same as the antenna 1 in Example 4 except that the end edge 18a of the base end surface 18 of the columnar conductor 4 coincides with the end edge 2f1 of the first plate-shaped conductor 2.

### Comparative Example 1

An antenna 101 described below was created as a model in Comparative example 1.

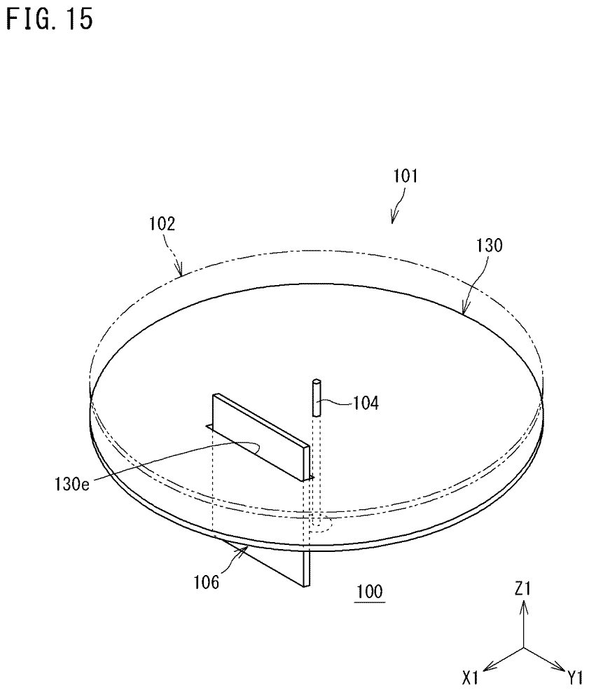

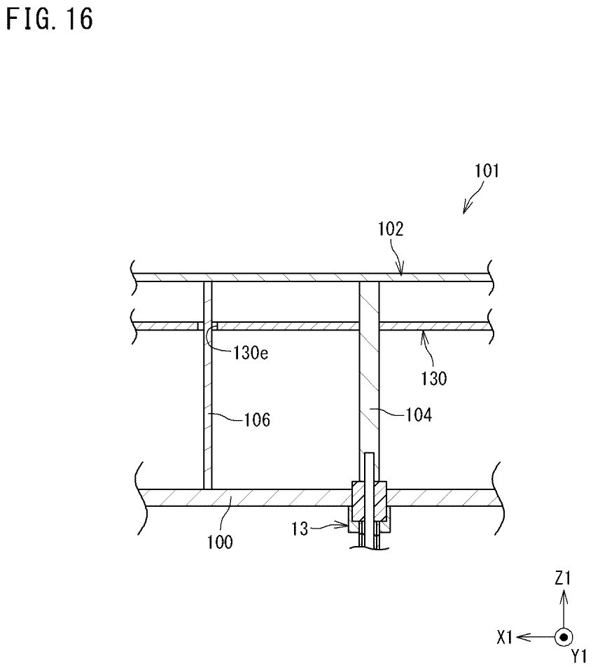

FIG. 15 is a perspective view of the antenna 101 according to Comparative example 1, and FIG. 16 is a sectional view of the antenna 101 along X-Z plane. In FIG. 15, for facilitating the understanding, a first plate-shaped conductor 102 is shown by a virtual line (two-dot dashed line). FIG. 16 shows a cross-section passing through the Y-direction center of the antenna 101.

As shown in FIG. 15 and FIG. 16, the antenna 101 in Comparative example 1 is provided on a ground conductor 100. The antenna 101 includes the first plate-shaped conductor 102, a second plate-shaped conductor 130, a columnar conductor 104, and a short-circuit conductor 106.

The first plate-shaped conductor 102, the second plate-shaped conductor 130, a hole 130e, the columnar conductor 104, and the short-circuit conductor 106 respectively correspond to the first plate-shaped conductor 2, the second plate-shaped conductor 30, the hole 30e, the columnar conductor 4, and the short-circuit conductor 6 in the fourth embodiment.

The columnar conductor 104 in Comparative example 1 is a rod-shaped member having a diameter of 1.3 mm.

The width dimension in the Y direction of the short-circuit conductor 106 in Comparative example 1 was set at 20 mm.

The other dimensions were set in accordance with the first plate-shaped conductor 2, the second plate-shaped conductor 30, the columnar conductor 4, and the short-circuit conductor 6 in the fourth embodiment.

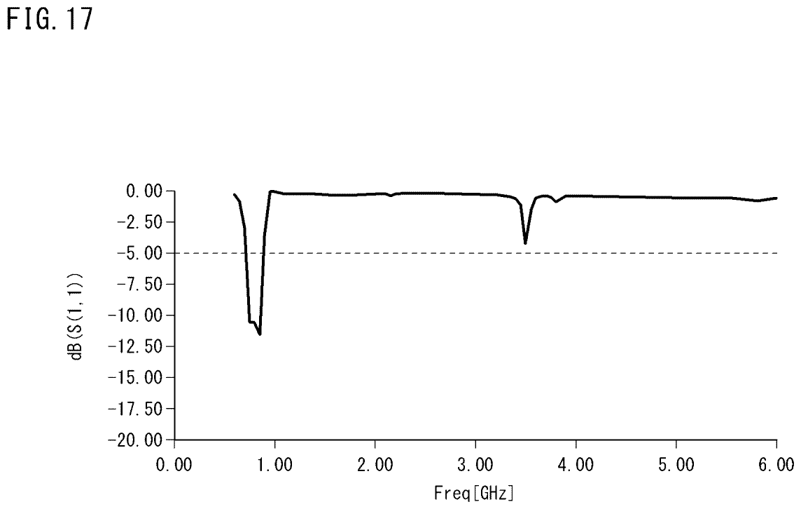

FIG. 17 shows a frequency characteristic of return loss in Comparative example 1.

As shown in FIG. 17, in Comparative example 1, return loss was −5 dB or less in a range of about 700 to 900 MHz. However, return loss in the other bands is greater than −5 dB. The frequency band in which return loss is −5 dB or less can be determined to be an adaptable frequency band of the antenna.

Thus, Comparative example 1 is adaptable to only a comparatively low frequency band of 1 GHz or lower.

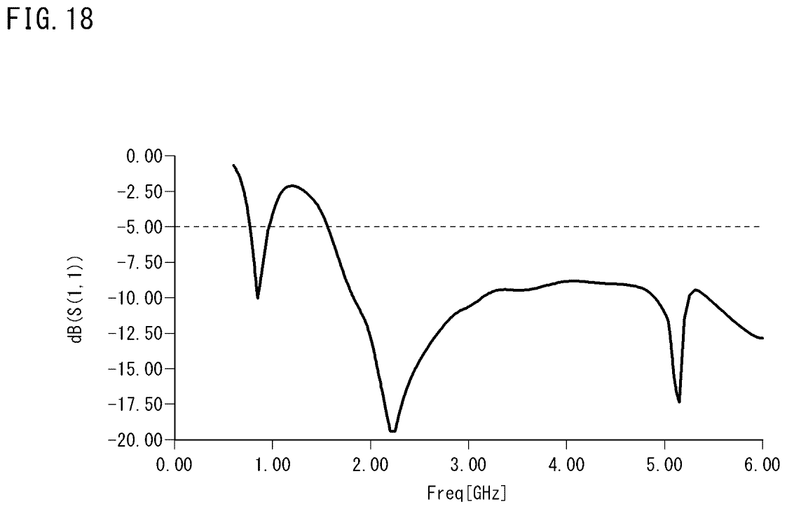

FIG. 18 shows a frequency characteristic of return loss in Example 1.

As shown in FIG. 18, in Example 1, return loss is −5 dB or less in a range of about 750 to 900 MHz. Further, return loss in a frequency band of 1.6 GHz or higher is −5 dB or less. In FIG. 17, return loss in a frequency band from 1.6 GHz to at least 6 GHz is −5 dB or more.

Thus, Example 1 is adaptable to a comparatively low frequency band of 1 GHz or lower and a frequency band of 1.6 GHz or higher.

From this result, it is found that, in Example 1, the antenna 1 adaptable to a wider frequency band than in Comparative example 1 can be obtained.

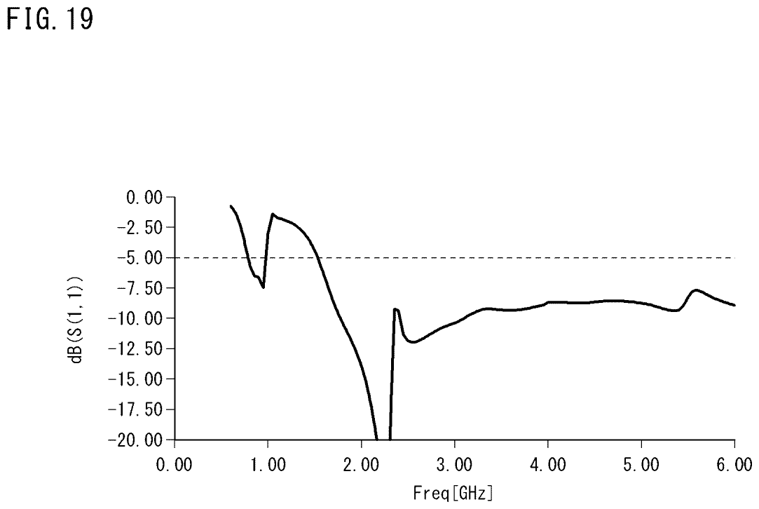

FIG. 19 shows a frequency characteristic of return loss in Example 2.

As shown in FIG. 19, in Example 2, return loss is −5 dB or less in a range of about 750 to 950 MHz. Further, return loss in a frequency band of 1.5 GHz or higher is −5 dB or less.

In Example 2, of adaptable frequency bands, a frequency band of 1 GHz or less is made wider than in Example 1.

From this result, it is found that, in Example 2, a comparatively low frequency band of adaptable frequency bands can be made wide by addition of the second plate-shaped conductor 30.

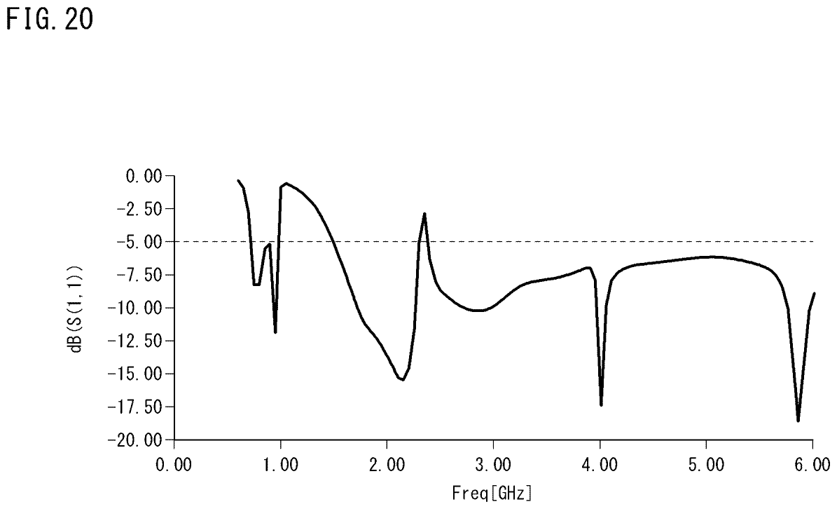

FIG. 20 shows a frequency characteristic of return loss in Example 3.

As shown in FIG. 20, in Example 3, return loss is −5 dB or less in a range of about 700 to 950 MHz. In addition, return loss in a frequency band of 1.5 to 2.3 GHz is −5 dB or less. Further, return loss in a frequency band of 2.4 GHz or higher is −5 dB or less.

In Example 3, of adaptable frequency bands, a frequency band of 1 GHz or lower is made wider than in Example 2.

From this result, it is found that, in Example 3, a comparatively low frequency band of adaptable frequency bands can be made wide by a configuration in which the short-circuit conductor 6 curved in accordance with the side surface 20 of the columnar conductor 4 is located so as to be opposed to the side surface 20 with the interval D therebetween.

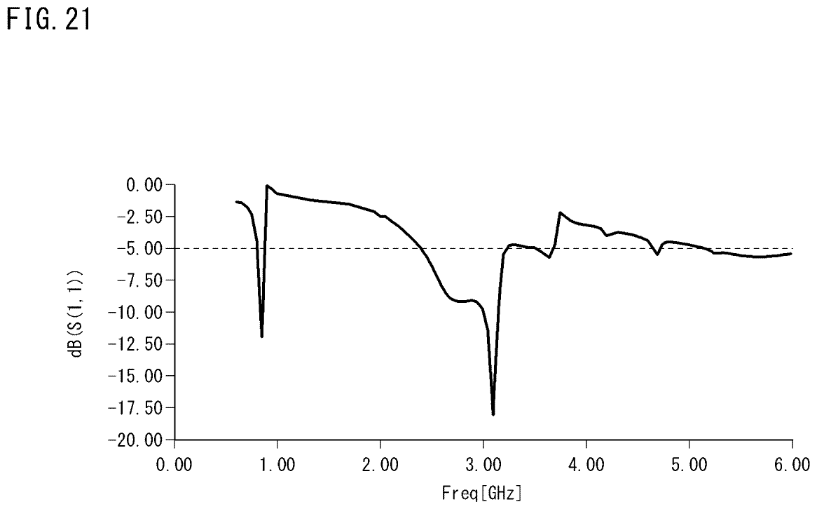

FIG. 21 shows a frequency characteristic of return loss in Example 4.

As shown in FIG. 21, in Example 4, return loss is −5 dB or less in a range of about 800 to 900 MHz. In addition, return loss in a frequency band of 2.4 to 3.7 GHz is −5 dB or less. Further, return loss in a frequency band of 5.2 GHz or higher is −5 dB or less.

In Example 4, of adaptable frequency bands, a frequency band of 1 GHz or higher is narrower than in Example 1 to 3, but there is a partial band that is adaptable.

From this result, it is found that, in Example 4, it is possible to adapt to a comparatively low frequency band of 1 GHz or lower and a partial frequency band of 2.4 GHz or higher and thus the antenna 1 adaptable to a wider frequency band than in Comparative example 1 is obtained.

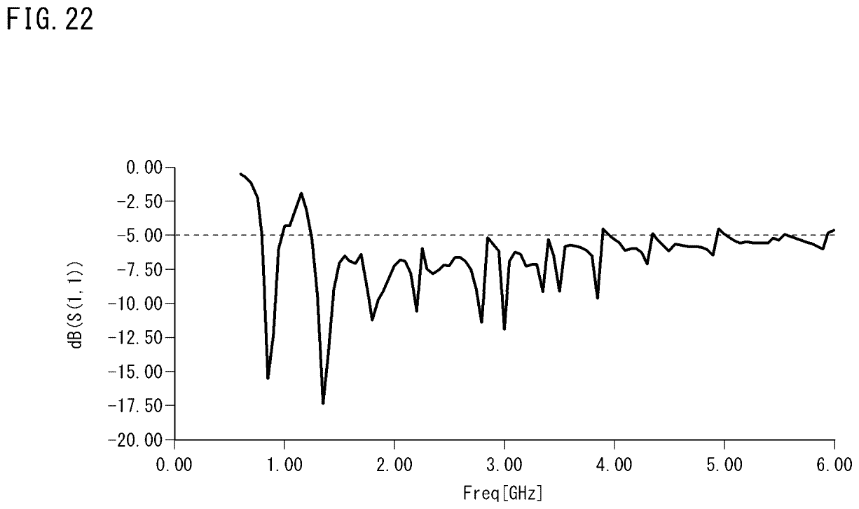

FIG. 22 shows a frequency characteristic of return loss in Example 5.

As shown in FIG. 22, in Example 5, return loss is −5 dB or less in a range of about 800 to 950 MHz. Further, return loss in a frequency band of 1.3 GHz or higher is −5 dB or less.

Thus, in Example 5, it is possible to adapt to a comparatively low frequency band of 1 GHz or lower and a frequency band of 1.3 GHz or higher.

From this result, it is found that, in Example 5, the antenna 1 adaptable to a wider frequency band than in Comparative example 1 is obtained.

### OTHERS

It should be noted that the embodiments disclosed herein are merely illustrative and not restrictive in all aspects.

The scope of the present disclosure is defined by the scope of the claims rather than the above description, and is intended to include meaning equivalent to the scope of the claims and all modifications within the scope.

1. An antenna comprising:
a first plate-shaped conductor; and
a columnar conductor provided at a plate surface of the first plate-shaped conductor so as to protrude therefrom, wherein
a distal end of the columnar conductor has a feeding point, and
a sectional area of a cross-section of the columnar conductor along the plate surface is larger than an area of an end surface of the distal end.

2. The antenna according to claim 1, wherein a shape of the columnar conductor is a shape having a taper-shaped side surface tapered from the first plate-shaped conductor side toward the distal end side.

3. The antenna according to claim 2, wherein the side surface is a convex curved surface.

4. The antenna according to claim 2, wherein
a shape of the side surface is a side surface shape of a solid of revolution about a revolution axis that is a line perpendicular to the plate surface, and
when the revolution axis is defined as a y axis and a line perpendicular to the revolution axis at the distal end is defined as an x axis, a contour curve of the side surface in a cross-section of the columnar conductor along a plane including the revolution axis satisfies the following formula:
y=ax^{P}
where x≥0, a>0, and P≥1.

5. The antenna according to claim 1, wherein
a shape of the columnar conductor is a shape having a step-shaped side surface expanding stepwise from the distal end side toward the first plate-shaped conductor side.

6. The antenna according to claim 1, wherein
the first plate-shaped conductor has a band shape.

7. The antenna according to claim 6, wherein the columnar conductor is provided on a first end side in a longitudinal direction of the first plate-shaped conductor.

8. The antenna according to claim 6, wherein a width dimension of the first plate-shaped conductor and a width dimension of the cross-section of the columnar conductor along the plate surface are the same.

9. The antenna according to claim 8, wherein a short side on a first end side in a longitudinal direction of the first plate-shaped conductor has a shape along a contour shape of the cross-section of the columnar conductor along the plate surface.

10. The antenna according to claim 1, wherein the columnar conductor is provided at a position shifted from a center of the first plate-shaped conductor, on the plate surface.

11. The antenna according to claim 10, wherein a center of the first plate-shaped conductor is a center of gravity of a contour shape of the first plate-shaped conductor as seen in a plan view, or a center of a circumscribed circle of the contour shape.

12. The antenna according to claim 1, further comprising a short-circuit conductor provided at the plate surface so as to protrude therefrom and grounding the first plate-shaped conductor.

13. The antenna according to claim 12, wherein the short-circuit conductor has a plate shape curved in accordance with a side surface of the columnar conductor, and is located so as to be opposed to the side surface of the columnar conductor with a predetermined interval therebetween.

14. The antenna according to claim 1, further comprising a second plate-shaped conductor provided at a side surface of the columnar conductor so as to protrude therefrom and located on the plate surface side of the first plate-shaped conductor so as to be opposed to the first plate-shaped conductor.
